(19) United States
(12) Patent Application Publication
(10) Pub. No.: US 2019/0389135 A1
(43) Pub. Date: Dec. 26, 2019

(54) ADJUSTMENT METHOD OF SHAPING DEVICE

(71) Applicant: MIMAKI ENGINEERING CO., LTD., Nagano (JP)

(72) Inventor: Kenta Imai, Nagano (JP)

(73) Assignee: MIMAKI ENGINEERING CO., LTD., Nagano (JP)

(21) Appl. No.: 16/443,885

(22) Filed: Jun. 18, 2019

(30) Foreign Application Priority Data
Jun. 26, 2018 (JP) 2018-120605
Nov. 7, 2018 (JP) 2018-209962

(51) Int. Cl. B29C 64/393; B33Y 10/00; B33Y 50/02; B29C 64/112

(52) U.S. Cl. CPC B29C 64/393; B33Y 10/00; B33Y 30/00; B29C 64/112; B33Y 50/02

(57) ABSTRACT

An adjustment method of a shaping device including a table on which a stereoscopic shaped object is shaped, and an inkjet head that ejects ink toward the table to form the shaped object, the method including an electronic balance installation process of placing an electronic balance for measuring weight of an ink ejected by the inkjet head on the table, and an ink ejection amount setting process of measuring the weight of the ink ejected by the inkjet head by the electronic balance placed on the table, and adjusting and setting the amount of ink ejected by the inkjet head based on the measurement result.

### CROSS REFERENCE TO RELATED APPLICATIONS

This application claims the priority benefit of Japanese Patent Application No. 2018-120605, filed on Jun. 26, 2018, and Japanese Patent Application No. 2018-209962, filed on Nov. 7, 2018. The entirety of each of the above-mentioned patent applications is hereby incorporated by reference herein and made a part of this specification.

### TECHNICAL FIELD

The present disclosure relates to an adjustment method of a shaping device that manufactures a stereoscopic shaped object.

### DESCRIPTION OF THE BACKGROUND ART

Conventionally, a shaping device (three-dimensional shaped object manufacturing device) for manufacturing a stereoscopic shaped object is known (see, e.g., Japanese Unexamined Patent Publication No. 2018-89963, Patent Literature 1). The shaping device described in Japanese Unexamined Patent Publication No. 2018-89963 includes a table on which a shaped object is shaped and placed, a plurality of inkjet heads for ejecting ink toward the table, and a carriage on which the inkjet head is mounted. The inkjet head ejects an ultraviolet curable ink. The carriage is mounted with an ultraviolet irradiator that irradiates the ink ejected by the inkjet head with an ultraviolet light to cure the ink. In the shaping device described in Japanese Unexamined Patent Publication No. 2018-89963, an ink layer formed by an ink ejected from an inkjet head and cured by an ultraviolet light irradiated from an ultraviolet irradiator is sequentially layered on the upper surface of a table to manufacture a stereoscopic shaped object.

Patent Literature 1: Japanese Unexamined Patent Publication No. 2018-89963

### SUMMARY

In the shaping device described in Japanese Unexamined Patent Publication No. 2018-89963, an ink layer formed by an ink ejected from an inkjet head and cured by an ultraviolet light irradiated from an ultraviolet irradiator is sequentially layered on the upper surface of a table to manufacture a stereoscopic shaped object. Therefore, in this shaping device, it is difficult to manufacture a shaped object of an appropriate shape unless the amount of ink ejected by the inkjet head is appropriately controlled.

The present disclosure provides an adjustment method of a shaping device for manufacturing a stereoscopic shaped object in which an amount of ink ejected by an inkjet head is appropriately controlled.

To solve the problem described above, an adjustment method of a shaping device of the present disclosure relates to an adjustment method of a shaping device including a table on which a stereoscopic shaped object is shaped, and an inkjet head that ejects ink toward the table to form the shaped object, the adjustment method including an electronic balance installation process of placing an electronic balance for measuring weight of an ink ejected by the inkjet head on the table, and an ink ejection amount setting process of measuring the weight of the ink ejected by the inkjet head by the electronic balance placed on the table, and adjusting and setting the amount of ink ejected by the inkjet head based on the measurement result.

In the present disclosure, for example, the inkjet head includes a piezoelectric element that ejects ink from a nozzle of the inkjet head; and in the ink ejection amount setting process, a voltage applied to the piezoelectric element is adjusted and set.

According to the adjustment method of the shaping device of the present disclosure, in the ink ejection amount setting process, the weight of the ink ejected by the inkjet head is measured, and the amount of ink ejected by the inkjet head is adjusted and set based on the measurement result. Thus, for example, by adjusting the shaping device through the adjustment method of the present disclosure, ink of a constant amount can be ejected from the nozzle when a constant voltage is applied to the piezoelectric element if the inkjet head includes a piezoelectric element. Therefore, by adjusting the shaping device through the adjustment method of the present disclosure, the amount of ink ejected by the inkjet head can be appropriately controlled in the shaping device, and as a result, an appropriate shaped object can be manufactured.

Furthermore, in the adjustment method of the shaping device of the present disclosure, in the electronic balance installation process, the electronic balance is placed on the table on which the shaped object is shaped, and in the ink ejection amount setting process, the weight of the ink ejected from the inkjet head is measured by the electronic balance placed on the table. Therefore, a space dedicated for installing the electronic balance does not need to be provided in the shaping device by adjusting the shaping device through the adjustment method of the present disclosure. Therefore, the shaping device can be miniaturized by adjusting the shaping device through the adjustment method of the present disclosure.

In the present disclosure, the ink ejection amount setting process preferably includes an ink ejection process in which the inkjet head automatically ejects the ink to an ink receiving container placed on the electronic balance, an ink weight measurement process in which the electronic balance automatically measures the weight of the ink ejected by the inkjet head in the ink ejection process, and an ink ejection amount correction process of automatically correcting the amount of ink ejected by the inkjet head based on a measurement result of the ink weight measurement process. According to such a configuration, the amount of ink ejected by the inkjet head can be automatically adjusted and set in the ink ejection amount setting process.

In the present disclosure, for example, in the ink ejection amount setting process, the ink ejection process and the ink weight measurement process are performed again after the ink ejection amount correction process.

In the present disclosure, for example, the inkjet head is formed with a plurality of nozzles for ejecting ink; in the inkjet head, the plurality of nozzles arrayed in a front and back direction orthogonal to an up and down direction form a nozzle row; in the ink ejection process, the nozzle row automatically ejects ink; in the ink weight measurement process, the electronic balance automatically measures the weight of the ink ejected by the nozzle row in the ink ejection process; and in the ink ejection amount correction process, the amount of ink ejected by the nozzle row is automatically corrected based on the measurement result in the ink weight measurement process.

Preferably in the present disclosure, the shaping device includes a plurality of the inkjet heads arrayed in a left and right direction orthogonal to the up and down direction and the front and back direction; and assuming that one of the left and right directions is a first direction, and the other is a second direction, in the ink ejection amount setting process, the amount of ink ejected by the nozzle row is adjusted and set in order for every nozzle row from the nozzle row disposed at an end in the first direction toward the nozzle row disposed at an end in the second direction with respect to all the nozzle rows included in the shaping device.

According to such a configuration, by aligning the nozzle row in which the ejection amount of ink is adjusted and set and the ink receiving container once, the ejection amount of ink from the relevant nozzle row can be adjusted and set. Therefore, for example, compared with a case in which the amount of ink ejected by the nozzle row is adjusted and set in order for every nozzle row with respect to all the nozzle rows included in the shaping device after the ink ejection process and the ink weight measurement process are performed (i.e., after the weight of the ink ejected by the nozzle row is measured) in order for every nozzle row with respect to all the nozzle rows included in the shaping device.

In the present disclosure, the shaping device includes a plurality of inkjet heads arrayed in a left and right direction orthogonal to an up and down direction and a front and back direction; and assuming that one of the left and right direction is a first direction and the other is a second direction, in the ink ejection amount setting process, the ink ejection process and the ink weight measurement process may be performed in order for every nozzle row from the nozzle row disposed at an end in the first direction toward the nozzle row disposed at an end in the second direction with respect to all the nozzle rows included in the shaping device, and a determination process of automatically determining whether or not a weight of the ink measured in the ink weight measurement process or an amount of ink calculated based on a weight of the ink measured in the ink weight measurement process is within a predetermined reference range may also be performed, the amount of ink ejected by the nozzle row being adjusted and set in order for every nozzle row with respect to the nozzle row in which the weight or the amount of ink is outside the reference range after the determination process.

In this case, after the determination process, adjustment and setting of the amount of ink ejected by the nozzle row are performed only on the nozzle row in which the weight or the amount of ink is outside the reference range, and thus for example, the adjustment time of the shaping device can be shortened compared with the case where adjustment and setting of the amount of ink ejected by the nozzle row are performed for all the nozzle rows included in the shaping device after the determination process.

Preferably, in the present disclosure, assuming that the nozzle row in which the weight or the amount of ink is outside the reference range is an adjustment nozzle row, after the determination process, the amount of ink ejected by the adjustment nozzle row is adjusted and set in order for every nozzle row from the adjustment nozzle row disposed on a most second direction side toward the adjustment nozzle row disposed on a most first direction side. According to such a configuration, compared with a case in which the amount of ink ejected by the adjustment nozzle row is adjusted and set in order for every adjustment nozzle row from the adjustment nozzle row disposed at the most first direction side to the adjustment nozzle row disposed at the most second direction side after the determination process, the time for aligning the adjustment nozzle row in which the ejection amount of ink is adjusted and set first and the ink receiving container can be shortened after the determination process. Therefore, the adjustment time of the shaping device can be further shortened.

Here, in the shaping device adjusted through the adjustment method of the present disclosure, generally, the viscosity of the ink in the nozzle may change after the ink ejection process due to the influence of heat or the like generated when ejecting ink. When the viscosity of the ink in the nozzle changes, for example, the amount of ink ejected from the nozzle may change even if a constant voltage is applied to the piezoelectric element.

Further, for example, when adjusting and setting the amount of ink ejected by the nozzle row in order for every nozzle row from the nozzle row disposed at the end in the first direction toward the nozzle row disposed at the end in the second direction with respect to all the nozzle rows included in the shaping device, in the ink ejection process after the ink ejection amount correction process with respect to a certain nozzle row, the elapsed time from the previous ink ejection process becomes short, and thus the viscosity of the ink ejected in the ink ejection process after the ink ejection amount correction process may be changed from the viscosity of the ink ejected in the previous ink ejection process. Therefore, in this embodiment, although the amount of ink ejected by the nozzle row is corrected in the ink ejection amount correction process, the amount of ink ejected by the nozzle row in the ink ejection process after the ink ejection amount correction process may not become the ejection amount corresponding to the correction in the ink ejection amount correction process, and the amount of ink ejected by the nozzle row may not be appropriately set in the ink ejection amount setting process.

Further, for example, when adjusting and setting the amount of ink ejected by the adjustment nozzle row in order for every adjustment nozzle row from the adjustment nozzle row disposed on the most second direction side toward the adjustment nozzle row disposed on the most first direction side after the determination process, in particular, in the ink ejection process after the determination process with respect to the adjustment nozzle row disposed on the most second direction side, the elapsed time from the ink ejection process before the determination process becomes short. Thus, in this case, in particular, in the adjustment nozzle row disposed on the most second direction side, the viscosity of the ink ejected in the ink ejection process after the determination process may be changed from the viscosity of the ink ejected in the ink ejection process before the determination process. Therefore, the ejection amount of ink in the ink ejection process before the determination process and the ejection amount of ink in the ink ejection process after the determination process change, and the amount of ink ejected by the nozzle row may not be appropriately set in the ink ejection amount setting process.

Therefore, in the present disclosure, the inkjet head is preferably an ink circulation type inkjet head having an ink supply port to which the ink is supplied and an ink discharge port from which the ink is discharged. According to the study of the inventor of the present application, when configured in such a manner, even if the amount of ink ejected by the nozzle row is adjusted and set in order for every nozzle row from the nozzle row disposed at the end in the first direction toward the nozzle row disposed at the end in the second direction for all the nozzle rows included in the shaping device, the fluctuation amount between the viscosity of the ink ejected in the ink ejection process after the ink ejection amount correction process and the viscosity of the ink ejected in the previous ink ejection process can be suppressed, and the amount of ink ejected by the nozzle row in the ink ejection process after the ink ejection amount correction process can be made as the ejection amount corresponding to the correction in the ink ejection amount correction process. Furthermore, according to the study of the inventor of the present application, when configured in such a manner, even if the amount of ink ejected by the adjustment nozzle row is adjusted and set in order for every adjustment nozzle row from the adjustment nozzle row disposed at the most second direction side toward the adjustment nozzle row disposed at the most first direction side after the determination process, the fluctuation amount between the viscosity of the ink ejected in the ink ejection process after the determination process and the viscosity of the ink ejected in the ink ejection process before the determination process can be suppressed, and the difference between the ejection amount of ink in the ink ejection process before the determination process and the ejection amount of ink in the ink ejection process after the determination process can be suppressed.

In the present disclosure, preferably, the shaping device includes a table up-down moving mechanism that moves the table up and down, a carriage on which the inkjet head is mounted, and a carriage moving mechanism that moves the carriage in a main scanning direction; and in the electronic balance installation process, the table is lowered to a predetermined position and the carriage is moved to the predetermined position, and then the electronic balance on which an ink receiving container is placed is installed on a lower side of the inkjet head.

If the carriage is moved to a predetermined position after the electronic balance on which the ink receiving container is placed is installed on the table lowered to a predetermined position, the inkjet head that moves with the carriage may come into contact with the ink receiving container on the table, but with such a configuration, if the ink receiving container is about to make contact with the inkjet head when installing the electronic balance on which the ink receiving container is placed on the table, the electronic balance on which the ink receiving container is placed can be installed on the table after lowering the table to a position where the ink receiving container does not come into contact with the inkjet head. Therefore, the contact between the inkjet head and the ink receiving container can be reliably prevented.

In the present disclosure, preferably, in the electronic balance installation process, a mark of a placement position of the electronic balance is printed on the table by the inkjet head before the table is lowered to a predetermined position. With this configuration, the electronic balance can be easily installed on the table as the electronic balance merely needs to be placed on the mark printed on the table.

Therefore, the amount of ink ejected by the inkjet head in the shaping device can be appropriately controlled by adjusting the shaping device through the adjustment method of the shaping device of the present disclosure.

### BRIEF DESCRIPTION OF THE DRAWINGS

FIG. 1 is a block diagram for explaining an adjustment method of a shaping device according to an embodiment of the present disclosure.

FIG. 2 is a schematic view for explaining a configuration of a device body shown in FIG. 1.

FIG. 3 is a schematic view for explaining a configuration of an inkjet head shown in FIG. 2.

FIG. 4 is a schematic view for explaining the configuration of the inkjet head shown in FIG. 2.

FIG. 5 is process chart for explaining an example of an electronic balance installation process in which an electronic balance is placed on a table shown in FIG. 2.

FIG. 6 is a flowchart for explaining an example of an ink ejection amount setting process of adjusting and setting the amount of ink ejected by an inkjet head shown in FIG. 2.

FIG. 7 is a flowchart for explaining another example of the ink ejection amount setting process of adjusting and setting the amount of ink ejected by an inkjet head shown in FIG. 2.

FIG. 8 is a flowchart for explaining another example of the ink ejection amount setting process of adjusting and setting the amount of ink ejected by an inkjet head shown in FIG. 2.

### DESCRIPTION OF EMBODIMENTS

Hereinafter, an embodiment of the present disclosure will be described with reference to the accompanying drawings.

### Schematic Configuration of Shaping Device

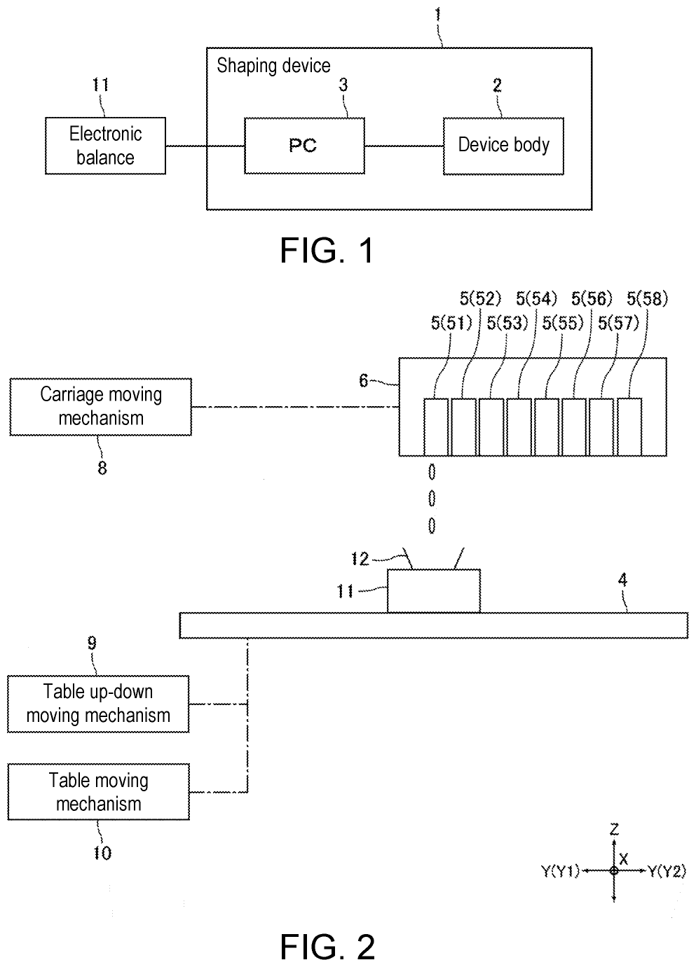

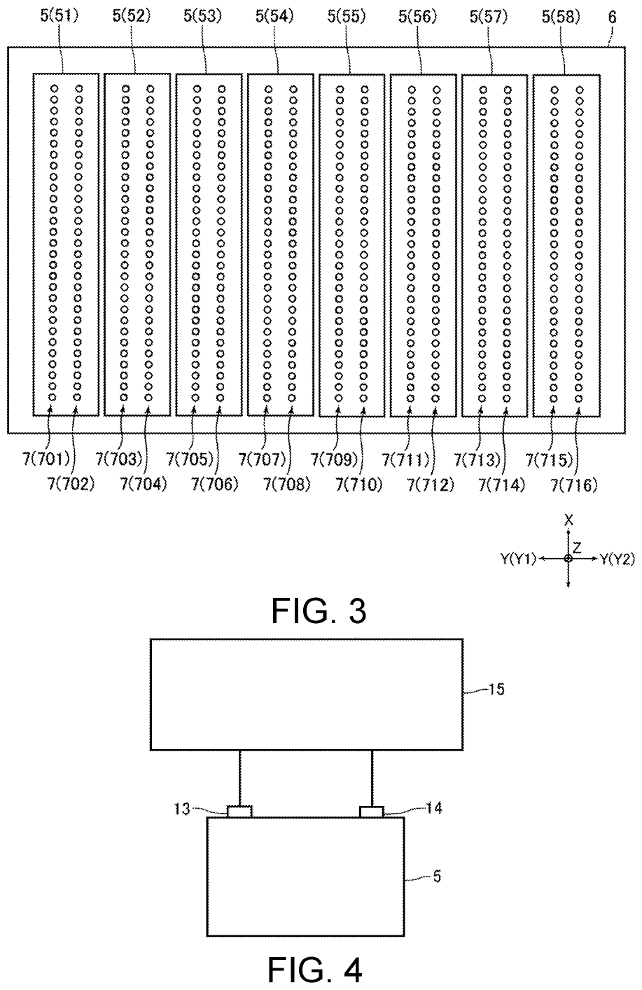

FIG. 1 is a block diagram for explaining an adjustment method of a shaping device 1 according to the embodiment of the present disclosure. FIG. 2 is a schematic view for explaining a configuration of a device body 2 shown in FIG. 1. FIG. 3 is a schematic view for explaining a configuration of an inkjet head 5 shown in FIG. 2. FIG. 4 is a schematic view for explaining a configuration of an inkjet head 5 shown in FIG. 2.

The shaping device 1 is an inkjet printer for manufacturing a stereoscopic shaped object (three-dimensional shaped object). The shaping device 1 includes a device body 2, which is a body of the shaping device 1 and a personal computer (PC) 3 incorporated in the shaping device 1. The device body 2 includes a table 4 on which a shaped object is shaped, an inkjet head 5 (hereinafter referred to as “head 5”) that ejects ink toward the table 4 to form a shaped object, and a carriage 6 on which the head 5 is mounted. The PC 3 may be externally attached to the shaping device 1.

Further, the device body 2 includes a carriage moving mechanism 8 for moving the carriage 6 in a main scanning direction (Y direction in FIG. 2 etc.) orthogonal to a up and down direction (Z direction in FIG. 2 etc.), a table up-down moving mechanism 9 for moving the table 4 up and down, and a table moving mechanism 10 for moving the table 4 in a sub-scanning direction (X direction in FIG. 2 etc.) orthogonal to the up and down direction and the main scanning direction. In the following description, the main scanning direction (Y direction) is referred to as “left and right direction”, and the sub-scanning direction (X direction) is referred to as “front and back direction”. Furthermore, the Y1 direction, which is one of the left and right directions, is referred to as “left direction”, and the Y2 direction, which is the other of the left and right directions, is referred to as “right direction”. The right direction (Y1 direction) of the present embodiment is a first direction, and the left direction (Y2 direction) is a second direction.

The carriage moving mechanism 8 includes, for example, a belt to which the carriage 6 is attached, two pulleys on which the belt is stretched across, and a motor for driving the pulleys. The table up-down moving mechanism 9 includes, for example, a nut member attached to the table 4, a screw member to which the nut member engages, and a motor for rotating the screw member. The table moving mechanism 10 includes, for example, a nut member attached to the table 4, a screw member to which the nut member engages, and a motor for rotating the screw member.

The carriage 6 has a plurality of heads 5 mounted thereon. That is, the shaping device 1 (specifically, device body 2) includes the plurality of heads 5. The shaping device 1 of the present embodiment includes eight heads 5. The eight heads 5 are mounted on the carriage 6 so as to be adjacent in the left and right direction. That is, the eight heads 5 are arrayed in the left and right direction. In the following description, when the eight heads 5 are represented in a distinguished manner, each of the eight heads 5 is denoted as “head 51 to head 58”. The heads 51 to 58 are arrayed in this order from left side to right side. That is, the head 51 is disposed at the left end, and the head 58 is disposed at the right end.

The head 5 is formed with a plurality of nozzles for ejecting ink. As shown in FIG. 4, in the head 5, a nozzle row 7 is configured by a plurality of nozzles arrayed in the front and back direction (specifically, arrayed linearly in the front and back direction). Furthermore, in the head 5, the plurality of nozzle rows 7 are arrayed in the left and right direction. In the present embodiment, two nozzle rows 7 are arrayed in the left and right direction. That is, the shaping device 1 of the present embodiment includes sixteen nozzle rows 7. Two nozzle rows 7 formed in one head 5 eject ink of the same color. In the following description, when representing the 16 nozzle rows 7 in a distinguished manner, each of the 16 nozzle rows 7 is referred to as “nozzle row 701 to nozzle row 716”.

The nozzle rows 701 and 702 are formed in the head 51, the nozzle rows 703 and 704 are formed in the head 52, the nozzle rows 705 and 706 are formed in the head 53, and the nozzle rows 707 and 708 are formed in the head 54. The nozzle rows 709 and 710 are formed in the head 55, the nozzle rows 711 and 712 are formed in the head 56, the nozzle rows 713 and 714 are formed in the head 57, and the nozzle rows 715 and 716 are formed in the head 58. The nozzle row 701 to the nozzle row 716 are arranged in this order from left to right. That is, the nozzle row 701 is disposed at the left end, and the nozzle row 716 is disposed at the right end.

The head 5 includes a piezoelectric element (piezo element) for ejecting ink from the nozzle. Specifically, the head 5 includes a plurality of piezoelectric elements for individually ejecting ink from each of the plurality of nozzles. The head 5 ejects an ultraviolet curable ink. The head 5 of the present embodiment is an ink circulation type head for circulating the ink inside the head 5, and includes an ink supply port 13 to which the ink is supplied and an ink discharge port 14 from which the ink is discharged. The shaping device 1 includes a sub-tank 15 connected to the head 5 through a piping. The shaping device 1 includes, for example, eight sub-tanks 15, and one sub-tank 15 is connected to each of the eight heads 5.

The sub-tank 15 is configured by a supply side sub-tank connected to the ink supply port 13 through a piping and in which ink supplied to the head 5 is accommodated, and a discharge side sub-tank connected to the ink discharge port 14 through a piping and in which the ink discharged from the head 5 is accommodated. A main tank (not shown) is connected to the supply side sub-tank through a piping. The ink can be supplied to the supply side sub-tank from the main tank.

An internal pressure of the supply side sub-tank and an internal pressure of the discharge side sub-tank are negative pressure. Furthermore, the internal pressure of the supply side sub-tank is higher than the internal pressure of the discharge side sub-tank. In the present embodiment, the ink is always supplied from the supply side sub-tank to the head 5 and the ink is discharged from the head 5 to the discharge side sub-tank due to the difference between the internal pressure of the supply side sub-tank and the internal pressure of the discharge side sub-tank. That is, the ink moves from the supply side sub-tank to the discharge side sub-tank through the head 5 due to the difference between the internal pressure of the supply side sub-tank and the internal pressure of the discharge side sub-tank, whereby the ink inside the head 5 circulates on a constant basis.

In the carriage 6, an ultraviolet irradiator (not shown) for irradiating the ink ejected by the head 5 with ultraviolet light to cure the ink, and a flattening roller (not shown) for flattening the surface (upper surface) of the ink ejected by the head 5 are mounted. In the shaping device 1, an ink layer formed of ink ejected from the head 5 and cured by the ultraviolet light irradiated from the ultraviolet irradiator is sequentially layered on the upper surface of the table 4 to manufacture a stereoscopic shaped object.

### Adjustment Method of Shaping Device

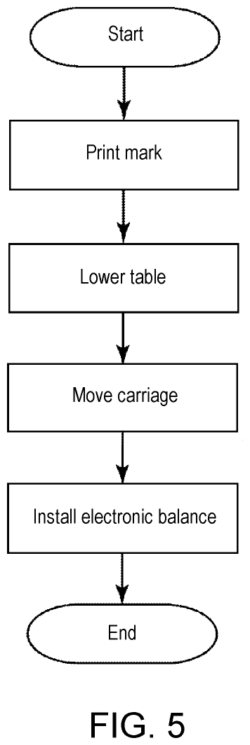

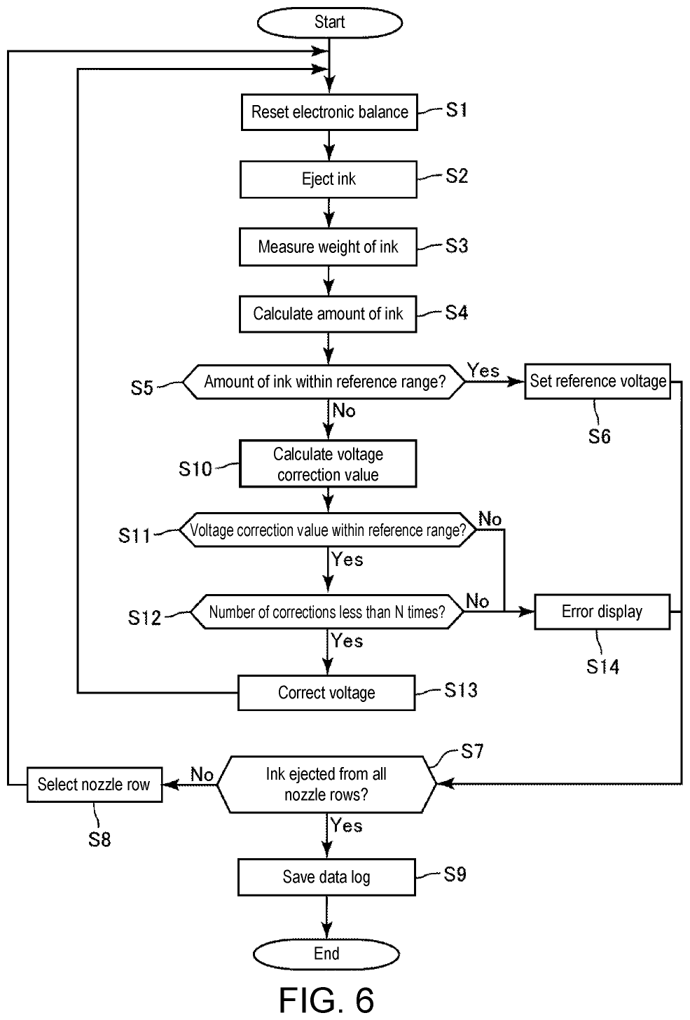

FIG. 5 is process chart for explaining an example of an electronic balance installation process in which an electronic balance 11 is placed on the table 4 shown in FIG. 2. FIG. 6 is a flowchart for explaining an example of an ink ejection amount setting process of adjusting and setting the amount of ink ejected by the head 5 shown in FIG. 2.

The amount of ink ejected by the head 5 is adjusted and set before manufacturing a shaped object by the shaping device 1. At this time, first, the electronic balance 11 for measuring the weight of the ink ejected by the head 5 is placed on the table 4 (electronic balance installation process). Specifically, in the electronic balance installation process, the electronic balance 11 on which an ink receiving container 12 is placed is placed on the table 4. The electronic balance 11 is electrically connected to a PC 3. The electronic balance 11 includes a screw for height adjustment, so that the height of the ink receiving container 12 placed on the electronic balance 11 can be adjusted.

In the electronic balance installation process, as shown in FIG. 5, a mark of a placement position of the electronic balance 11 is first printed on the table 4 by the head 5. That is, the head 5 ejects the ink, and the mark of the placement position of the electronic balance 11 is printed on the table 4. Thereafter, the table 4 is lowered to a predetermined position. Specifically, when the electronic balance 11 on which the ink receiving container 12 is placed is placed on the table 4, the table 4 is lowered to a position where an upper end of the ink receiving container 12 is disposed on a lower side than a lower surface of the head 5.

Thereafter, the carriage 6 is moved to a predetermined position. Specifically, the carriage 6 is moved to a position where the mark of the placement position of the electronic balance 11 is printed. Subsequently, the electronic balance 11 on which the ink receiving container 12 is placed is installed on the lower side of the head 5. Specifically, an operator of the shaping device 1 installs the electronic balance 11 on which the ink receiving container 12 is placed at the position where the mark is printed on the upper surface of the table 4. The table 4 may be lowered to the predetermined position after the carriage 6 is moved to the predetermined position.

When the electronic balance 11 is placed on the table 4, the weight of the ink ejected by the head 5 is measured by the electronic balance 11 placed on the table 4, and the amount of ink ejected by the head 5 is adjusted and set based on the measurement result (ink ejection amount setting process). Specifically, in the ink ejection amount setting process, the voltage applied to the piezoelectric element of the head 5 is adjusted and set based on the measurement result of the weight of the ink ejected by the head 5. In the ink ejection amount setting process, in each of the heads 5 (i.e., eight heads 51 to 58) included in the shaping device 1, the weight of the ink ejected by the head 5 is measured and the amount of ink ejected by the head 5 is adjusted and set based on the measurement results.

In the ink ejection amount setting process, when the operator presses a predetermined setting start button, first, as shown in FIG. 6, the electronic balance 11 automatically resets the weight based on a control command from the PC 3 (step S1). Thereafter, the head 5 automatically ejects the ink to the ink receiving container 12 placed on the electronic balance 11 based on the control command from the PC 3 (step S2, ink ejection process).

In step S2, a voltage is applied to the piezoelectric elements corresponding to one or a plurality of nozzle rows 7 which eject ink of the same color, the nozzle row 7 being selected in advance, and ink is ejected from the nozzle rows 7. That is, in step S2 (ink ejection process), the predetermined number of nozzle rows 7 automatically eject the ink. In step S2 of the present embodiment, one nozzle row 7 automatically ejects the ink. Furthermore, in the present embodiment, the nozzle row 701 automatically ejects the ink in the first step S2 after the setting start button is pressed by the operator. In step S2, for example, one nozzle row 7 ejects ink 50,000 times (50,000 shots).

Thereafter, the electronic balance 11 automatically measures the weight of the ink ejected from the head 5 to the ink receiving container 12 in step S2 (step S3, ink weight measurement process). That is, in step S3 (ink weight measurement process), the electronic balance 11 automatically measures the weight of the ink ejected by the predetermined number of nozzle rows 7 (specifically, one nozzle row 7) in step S2. The data of the weight measured in step S3 is input to the PC 3, and the PC 3 calculates the amount of ink ejected by the head 5 in step S2 (specifically, amount of ink ejected by one nozzle row 7) based on the input data (step S4).

Thereafter, the PC 3 determines whether or not the calculated amount of ink is within a predetermined reference range (step S5). If the calculated amount of ink is within the predetermined reference range in step S5, the PC 3 sets the voltage applied to the piezoelectric element in step S2 as a reference voltage (step S6). Then, the PC 3 determines whether the ink has been ejected from all the nozzle rows 7 (i.e., 16 nozzle rows 701 to 716) included in the shaping device 1 (step S7).

If the ink has not been ejected from all the nozzle rows 7 in step S7, one nozzle row 7 that has not ejected ink is selected (step S8), and the process is returned to step S1. In step S2 after step S8, the ink is ejected from the nozzle row 7 selected in step S8. In step S8 of the present embodiment, the nozzle row 7 adjacent to the right side of the nozzle row 7 that ejected ink in the previous step S2 is selected. For example, if the nozzle row 7 that ejected ink in the previous step S2 is the nozzle row 701, the nozzle row 702 is selected in step S8, and if the nozzle row 7 that ejected ink in the previous step S2 is the nozzle row 702, the nozzle row 703 is selected in step S8. Furthermore, in step S8, alignment between the selected nozzle row 7 and the ink receiving container 12 is performed.

On the other hand, if the ink has been ejected from all the nozzle rows 7 in step S7, the PC 3 saves the data log (step S9). When the data log is saved, the ink ejection amount setting process is terminated.

If the calculated amount of ink is outside the predetermined reference range in step S5, the PC 3 calculates a correction value (voltage correction value) of the voltage applied to the piezoelectric element corresponding to the nozzle row 7 that ejected ink in step S2 based on the calculated amount of ink (step S10). Thereafter, the PC 3 determines whether or not the voltage correction value calculated in step S10 is within a predetermined reference range (step S11). If the voltage correction value is within the predetermined reference range in step S11, the PC 3 determines whether or not the number of calculations of the voltage correction value is less than a predetermined number of times (whether or not the number of corrections is less than N times) (step S12).

If the number of calculations of the voltage correction value is less than the predetermined number of times in step S12, the PC 3 transmits the voltage correction value calculated in step S10 to the device body 2, the device body 2 corrects the voltage applied to the piezoelectric element in step S2 based on the voltage correction value received from the PC 3 (step S13), and the process is returned to step S1. On the other hand, if the voltage correction value is outside the predetermined reference range in step S11, or if the number of calculations of the correction value is greater than or equal to the predetermined number of times in step S12, the PC 3 makes an error display on a predetermined display unit of the device body 2 (step S14), and the process proceeds to step S7. For example, when the life duration of the head 5 is nearing, the voltage correction value calculated in step S10 may become large, and the voltage correction value may deviate from the predetermined reference range in step S11.

Steps S4, S5 and S10 to S13 of the present embodiment are ink ejection amount correction processes for automatically correcting the amount of ink ejected by the head 5 based on the measurement result in step S3 which is the ink weight measurement process. In the ink ejection amount correction process, the amount of ink ejected by the nozzle row 7 (specifically, the amount of ink ejected by one nozzle row 7) is automatically corrected based on the measurement result in the ink weight measurement process. Furthermore, in the ink ejection amount correction process, the voltage applied to the piezoelectric element in step S2 is automatically corrected, as described above. In the present embodiment, in the ink ejection amount setting process, the voltage applied to the piezoelectric element of the head 5 is automatically adjusted and set. That is, in the present embodiment, the amount of ink ejected by the head 5 is automatically adjusted and set in the ink ejection amount setting process.

As described above, after step S13, the process is returned to step S1 and steps S2 and S3 are performed, so that in the present embodiment, the ink ejection process and the ink weight measurement process are performed again after the ink ejection amount correction process. That is, in the ink ejection amount setting process, the ink ejection process and the ink weight measurement process are performed again after the ink ejection amount correction process.

Furthermore, as described above, the nozzle row 701 automatically ejects ink in the first step S2 after the setting start button is pressed by the operator. Further, as described above, when the reference voltage is set in step S6, the process proceeds to step S8 after step S7, and in step S8, the nozzle row 7 adjacent to the right side of the nozzle row 7 that ejected ink in the previous step S2 is selected, and hence in the ink ejection amount setting process, the amount of ink ejected by each nozzle row 7 is adjusted and set in order for every nozzle row 7 from the nozzle row 701 disposed at the left end toward the nozzle row 716 disposed at the right end with respect to all the nozzle rows 701 to 716 included in the shaping device 1. That is, in the ink ejection amount setting process, when the amount of ink ejected by one nozzle row 7 is adjusted and set, the amount of ink ejected by one nozzle row 7 disposed to the right of the relevant nozzle row 7 is adjusted and set.

### Main Effects of the Present Embodiment

As described above, in the present embodiment, the weight of the ink ejected by the head 5 is measured and the amount of ink ejected by the head 5 is adjusted and set based on the measurement result in the ink ejection amount setting process before manufacturing the shaped object with the shaping device 1. Therefore, in the present embodiment, ink of a constant amount can be ejected from the nozzle of the head 5 (specifically, from a single nozzle row 7) by applying a constant voltage to the piezoelectric element when manufacturing the shaped object with the shaping device 1. Therefore, in the present embodiment, the amount of ink ejected by the head 5 can be appropriately controlled when manufacturing a shaped object, and as a result, an appropriate shaped object can be manufactured.

In the present embodiment, the electronic balance 11 is placed on the table 4 on which the shaped object is shaped in the electronic balance installation process, and the weight of the ink ejected from the head 5 is measured with the electronic balance 11 placed on the table 4 in the ink ejection amount setting process. Therefore, in the present embodiment, a space dedicated for installing the electronic balance 11 does not need to be provided in the device body 2. Therefore, in the present embodiment, the device body 2 can be miniaturized.

According to the present embodiment, in the electronic balance installation process, the table 4 is lowered to a predetermined position and the carriage 6 is moved to a predetermined position, and thereafter, the electronic balance 11 on which the ink receiving container 12 is placed is installed on the lower side of the head 5. As described above, since the electronic balance 11 includes a screw for adjusting the height and hence the height of the ink receiving container 12 placed on the electronic balance 11 can be adjusted, if the carriage 6 is moved to a predetermined position after installing the electronic balance 11 on which the ink receiving container 12 is placed on the table 4 lowered to a predetermined position, the head 5 that moves with the carriage 6 may come into contact with the ink receiving container 12 on the table 4. However, in the present embodiment, if the ink receiving container 12 has a possibility of coming into contact with the head 5 when installing the electronic balance 11 on which the ink receiving container 12 is placed on the table 4, the electronic balance 11 on which the ink receiving container 12 is placed may be installed on the table 4 after the table 4 is lowered to a position where the ink receiving container 12 does not come into contact with the head 5. Therefore, in the present embodiment, the contact between the head 5 and the ink receiving container 12 can be reliably prevented.

According to the present embodiment, in the electronic balance installation process, the mark of the placement position of the electronic balance 11 is printed on the table 4 by the head 5 before the table 4 is lowered to the predetermined position. Therefore, in the present embodiment, the electronic balance 11 merely needs to be placed on the mark printed on the table 4. Thus, in the present embodiment, the electronic balance 11 can be easily installed on the table 4.

According to the present embodiment, in the ink ejection amount setting process, the amount of ink ejected by each nozzle row 7 is adjusted and set in order for every nozzle row 7 from the nozzle row 701 disposed at the left end toward the nozzle row 716 disposed at the right end with respect to all the nozzle rows 701 to 716 included in the shaping device 1. Thus, in the present embodiment, by aligning the nozzle row 7 in which the ejection amount of ink is adjusted and set and the ink receiving container 12 once, the ejection amount of ink from the relevant nozzle row 7 can be adjusted and set. Therefore, in the present embodiment, for example, compared with a case in which the amount of ink ejected by the nozzle row 7 is adjusted and set in order for every nozzle row 7 with respect to all the nozzle rows 701 to 716 after measuring the weight of the ink ejected by the nozzle row 7 in order for every nozzle row 7 with respect to all the nozzle rows 701 to 716, the adjustment time of the shaping device 1 can be shortened.

Here, in the shaping device 1, the viscosity of the ink in the nozzle may change after step S2 (ink ejection process) due to the influence of heat or the like generated when ejecting ink. When the viscosity of the ink in the nozzle changes, the amount of ink ejected from the nozzle may change even if a constant voltage is applied to the piezoelectric element. Furthermore, in the present embodiment, since the amount of ink ejected by each nozzle row 7 is adjusted and set in order for every nozzle row 7 from the nozzle row 701 disposed at the left end to the nozzle row 716 disposed at the right end with respect to all the nozzle rows 701 to 716, for a certain nozzle row 7, an elapsed time from the previous step S2 may become short in step S2 after step S13, and the viscosity of ink ejected in step S2 after step S13 may be different from the viscosity of ink ejected in the previous step S2.

Therefore, in this embodiment, although the amount of ink ejected by the nozzle row 7 is corrected in the ink ejection amount correction process, the amount of ink ejected by the nozzle row 7 in step S2 after the ink ejection amount correction process may not become the ejection amount corresponding to the correction in the ink ejection amount correction process, and the amount of ink ejected by the nozzle row 7 may not be appropriately set in the ink ejection amount setting process.

However, in the present embodiment, since the head 5 is an ink circulation type head, according to the study of the inventor of the present application, the fluctuation amount of the viscosity of the ink ejected in step S2 after the ink ejection amount correction process and the viscosity of the ink ejected in the previous step S2 can be suppressed so as to have the amount of ink ejected by the nozzle row 7 in step S2 after the ink ejection amount correction process as the ejection amount corresponding to the correction in the ink ejection amount correction process. Therefore, in the present embodiment, the amount of ink ejected by the nozzle row 7 can be appropriately set in the ink ejection amount setting process.

### Modified Example of Ink Ejection Amount Setting Process

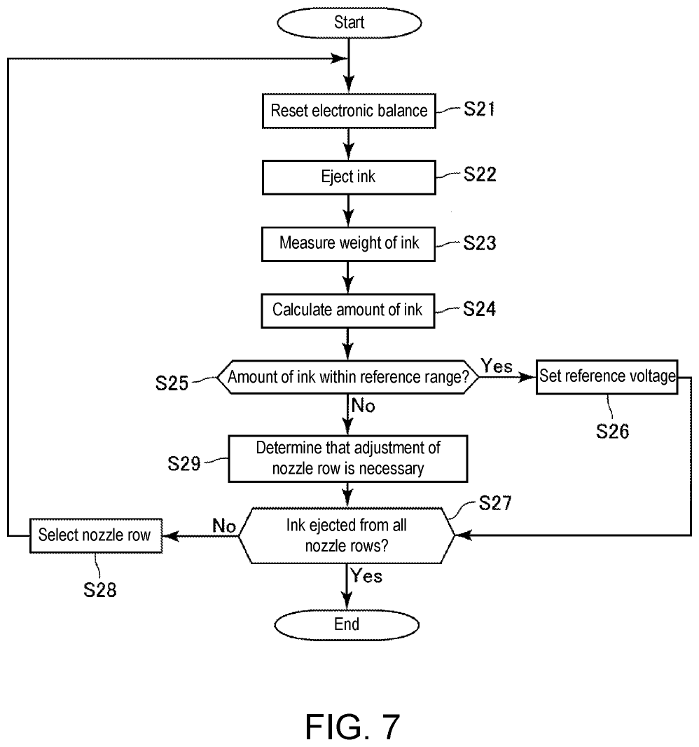

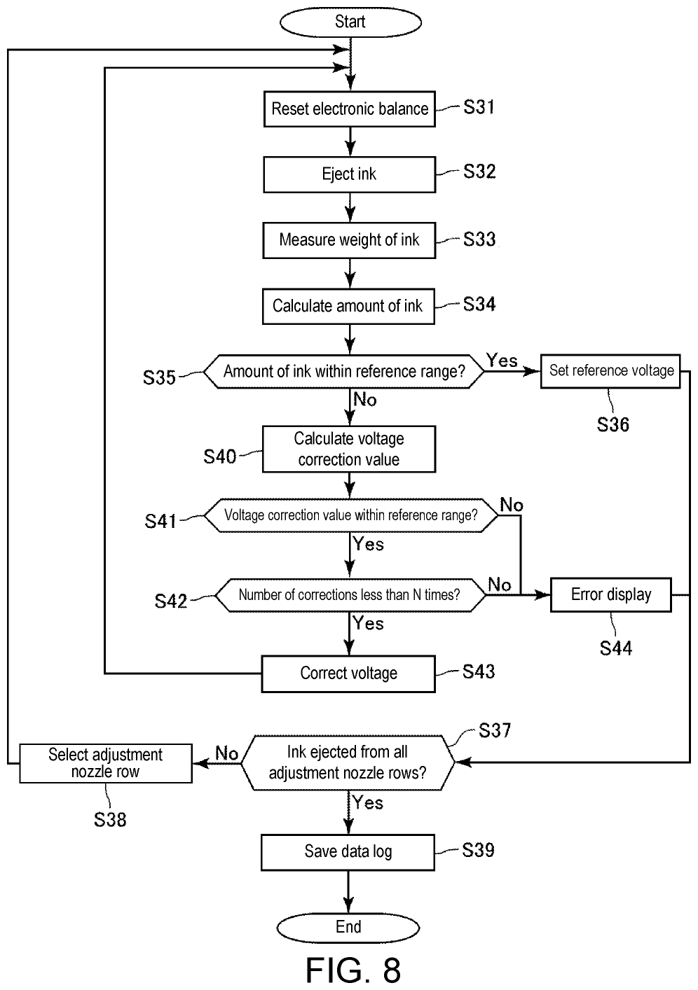

FIGS. 7 and 8 are flowcharts for explaining another example of the ink ejection amount setting process of adjusting and setting the amount of ink ejected by the head 5 shown in FIG. 2.

In the ink ejection amount setting process, first, the weight of the ink ejected by the nozzle row 7 may be measured in order for every nozzle row 7 with respect to all the nozzle rows 701 to 716, and the amount of ink ejected by the nozzle row 7 may be adjusted and set in order for every nozzle row 7 after the ejection weights of the ink of all the nozzle rows 7 are measured. Hereinafter, the ink ejection amount setting process according to the modified example will be described with a process of measuring the weight of the ink ejected by the nozzle row 7 as a first ink ejection amount setting process, and a process of adjusting and setting the amount of ink ejected by the nozzle row 7 as a second ink ejection amount setting process.

In the first ink ejection amount setting process, when the operator presses a predetermined setting start button, first, as shown in FIG. 7, the electronic balance 11 automatically resets the weight based on a control command from the PC 3 (step S21). Thereafter, the head 5 automatically ejects the ink to the ink receiving container 12 placed on the electronic balance 11 based on the control command from the PC 3 (step S22, ink ejection process). In step S22, as in the above described step S2, a voltage is applied to the piezoelectric element corresponding to one nozzle row 7 selected in advance, and the ink is ejected from the one nozzle row 7. Furthermore, in the first step S22 after the setting start button is pressed by the operator, the nozzle row 701 automatically ejects the ink.

Thereafter, the electronic balance 11 automatically measures the weight of the ink ejected by the head 5 (specifically, ejected by one nozzle row 7) to the ink receiving container 12 in step S22 (step S23, ink weight measurement process). The data of the weight measured in step S23 is input to the PC 3, and the PC 3 calculates the amount of ink ejected by the head 5 in step S22 (i.e., amount of ink ejected by one nozzle row 7) based on the input data (step S24).

Thereafter, the PC 3 determines whether or not the calculated amount of ink is within a predetermined reference range (step S25, determination process). That is, in step S25, whether or not the calculated amount of ink is within the predetermined reference range is automatically determined. If the calculated amount of ink is within the predetermined reference range in step S25, the PC 3 determines that the adjustment of the nozzle row 7 which ejected the ink in step S22 is unnecessary, and the voltage applied to the piezoelectric element in step S22 is set as a reference voltage (step S26). Thereafter, the PC 3 determines whether ink has been ejected from all the nozzle rows 7 (i.e., 16 nozzle rows 701 to 716) included in the shaping device 1 (step S27).

If the ink has not been ejected from all the nozzle rows 7 in step S27, one nozzle row 7 that has not ejected ink is selected (step S28), and the process is returned to step S21. In step S22 after step S28, the ink is ejected from the nozzle row 7 selected in step S28. Similar to the embodiment described above, in step S28, the nozzle row 7 adjacent to the right side of the nozzle row 7 that ejected ink in the previous step S22 is selected. For example, if the nozzle row 7 that ejected ink in the previous step S22 is the nozzle row 701, the nozzle row 702 is selected in step S28, and if the nozzle row 7 that ejected ink in the previous step S22 is the nozzle row 702, the nozzle row 703 is selected in step S28. Furthermore, in step S28, alignment between the selected nozzle row 7 and the ink receiving container 12 is performed.

If the calculated amount of ink is outside the predetermined reference range in step S25, the PC 3 determines that the adjustment of the nozzle row 7 that ejected ink in step S22 is necessary, stores the determination result (step S29), and then the process proceeds to step S27. In the case where the ink is ejected from all the nozzle rows 7 in step S27, the first ink ejection amount setting process is terminated.

After the first ink ejection amount setting process, a second ink ejection amount setting process is performed. In the second ink ejection amount setting process, the ejection amount of the ink in the nozzle row 7 determined that adjustment is necessary in step S29 is adjusted and set. That is, in the second ink ejection amount setting process, the ejection amount of ink of the nozzle row 7 in which the amount of ink calculated in step S24 is outside the reference range is adjusted and set. In the following description, the nozzle row 7 in which the amount of ink calculated in step S24 is outside the reference range is referred to as “adjustment nozzle row 7”.

When the first ink ejection amount setting process is completed, the second ink ejection amount setting process is automatically started. In the second ink ejection amount setting process, first, the electronic balance 11 automatically resets the weight based on the control command from the PC 3, as shown in FIG. 8 (step S31). Thereafter, based on the control command from the PC 3, one adjustment nozzle row 7 selected in advance automatically ejects ink to the ink receiving container 12 placed on the electronic balance 11 (step S32, ink ejection process). In this modified example, in the first step S32 after the second ink ejection amount setting process is started, the adjustment nozzle row 7 disposed at the rightmost side automatically ejects the ink. For example, when the nozzle row 716 is included in the adjustment nozzle row 7, in the first step S32 after the second ink ejection amount setting process is started, the nozzle row 716 automatically ejects the ink.

Thereafter, the electronic balance 11 automatically measures the weight of the ink ejected by the adjustment nozzle row 7 to the ink receiving container 12 in step S32 (step S33, ink weight measurement process). The data of the weight measured in step S33 is input to the PC 3, and the PC 3 calculates the amount of ink ejected by one adjustment nozzle row 7 in step S32 based on the input data (step S34).

Thereafter, the PC 3 determines whether or not the calculated amount of ink is within a predetermined reference range (step S35). If the calculated amount of ink is within the predetermined reference range in step S35, the PC 3 sets the voltage applied to the piezoelectric element in step S32 as a reference voltage (step S36). Thereafter, the PC 3 determines whether ink has been ejected from all the adjustment nozzle rows 7 (step S37).

If the ink has not been ejected from all the nozzle rows 7 in step S37, one nozzle row 7 that has not ejected ink is selected (step S38), and the process is returned to step S31. In step S32 after step S38, the ink is ejected from the adjustment nozzle row 7 selected in step S38. In the present modified example, in step S38, the adjustment nozzle row 7 adjacent to the left side of the adjustment nozzle row 7 that ejected ink in the previous step S32 is selected. For example, if the adjustment nozzle row 7 that ejected ink in the previous step S32 is the nozzle row 716 and the adjustment nozzle row 7 includes the nozzle row 715, the nozzle row 715 is selected in step S38. Furthermore, in step S38, alignment between the selected adjustment nozzle row 7 and the ink receiving container 12 is performed.

On the other hand, if the ink has been ejected from all the adjustment nozzle rows 7 in step S37, the PC 3 saves the data log (step S39). When the data log is saved, the second ink ejection amount setting process is terminated, and the ink ejection amount setting process is terminated.

If the calculated amount of ink is outside the predetermined reference range in step S35, the PC 3 calculates a correction value (voltage correction value) of the voltage applied to the piezoelectric element corresponding to the adjustment nozzle row 7 that ejected ink in step S32 based on the calculated amount of ink (step S40). Thereafter, the PC 3 determines whether or not the voltage correction value calculated in step S40 is within a predetermined reference range (step S41). If the voltage correction value is within the predetermined reference range in step S41, the PC 3 determines whether or not the number of calculations of the voltage correction value is less than a predetermined number of times (step S42).

If the number of calculations of the voltage correction value is less than the predetermined number of times in step S42, the PC 3 transmits the voltage correction value calculated in step S40 to the device body 2, the device body 2 corrects the voltage applied to the piezoelectric element in step S32 based on the voltage correction value received from the PC 3 (step S43), and the process is returned to step S31. On the other hand, if the voltage correction value is outside the predetermined reference range in step S41, or if the number of calculations of the correction value is greater than or equal to the predetermined number of times in step S42, the PC 3 makes an error display on a predetermined display unit of the device body 2 (step S44), and the process proceeds to step S37.

In this modified example, steps S34, S35 and S40 to S43 are ink ejection amount correction processes for automatically correcting the amount of ink ejected by the head 5 based on the measurement result in step S33, which is an ink weight measurement process, where in the ink ejection amount correction process, the voltage applied to the piezoelectric element in step S32 is automatically corrected.

Furthermore, in the present modified example, in the first ink ejection amount setting process, the ink ejection process (step S22) and the ink weight measurement process (step S23) are performed in order for every nozzle row 7 from the nozzle row 701 disposed at the left end to the nozzle row 716 disposed at the right end with respect to all the nozzle rows 701 to 716 included in the shaping device 1, and a determination process (step S25) is also performed to automatically determine whether or not the amount of ink calculated based on the weight of the ink measured in the ink weight measurement process is within a predetermined reference range.

Moreover, in the modified example, in the second ink ejection amount setting process after the first ink ejection amount setting process, the amount of ink ejected by the adjustment nozzle row 7 is adjusted and set in order for every adjustment nozzle row 7 with respect to the adjustment nozzle row 7 in which the amount of ink is outside the reference range. Specifically, the amount of ink ejected by the adjustment nozzle row 7 is adjusted and set in order for every adjustment nozzle row 7 from the adjustment nozzle row 7 disposed on the rightmost side to the adjustment nozzle row 7 disposed on the leftmost side.

According to the modified example, in the second ink ejection amount setting process, adjustment and setting of the amount of ink ejected by the nozzle row 7 are performed only on the adjustment nozzle row 7 in which the amount of ink is outside the reference range, and thus for example, the adjustment time of the shaping device 1 can be shortened compared with the case where the adjustment and the setting of the amount of ink ejected by the nozzle row 7 are performed for all the nozzle rows 701 to 716 in the second ink ejection amount setting process.

Furthermore, according to the present modified example, in the first ink ejection amount setting process, the ink ejection process and the ink weight measurement process are performed in order for every nozzle row 7 from the nozzle row 701 disposed at the left end to the nozzle row 716 disposed at the right end, and in the second ink ejection amount setting process, the amount of ink ejected by the adjustment nozzle row 7 is adjusted and set in order for every adjustment nozzle row 7 from the adjustment nozzle row 7 disposed on the rightmost side to the adjustment nozzle row 7 disposed on the leftmost side. Therefore, compared with a case in which the amount of ink ejected by the adjustment nozzle row 7 is adjusted and set in order for every adjustment nozzle row 7 from the adjustment nozzle row 7 disposed at the leftmost side to the adjustment nozzle row 7 disposed at the rightmost side in the second ink ejection amount setting process, the time for aligning the adjustment nozzle row 7 in which the ejection amount of ink is adjusted and set and the ink receiving container 12 immediately after the start of the second ink ejection amount setting process. Therefore, the adjustment time of the shaping device 1 can be further shortened.

In the present modified example, the elapsed time from the end of ejection of ink in step S22 to the start of ejection of ink in step S32 immediately after the start of the second ink ejection amount setting process becomes short particularly in the adjustment nozzle row 7 disposed on the rightmost side. Therefore, the viscosity of the ink ejected in step S32 immediately after the start of the second ink ejection amount setting process may change from the viscosity of the ink ejected in step S22, and the ejection amount of ink ejected in step S32 immediately after the start of the second ink ejection amount setting process and the ejection amount of ink in step S22 may change in the adjustment nozzle row 7 disposed at the rightmost position, in particular, due to the influence of heat and the like generated when ejecting ink. Furthermore, when the ejection amount of ink ejected in step S32 immediately after the start of the second ink ejection amount setting process and the ejection amount of ink in step S22 change, the amount of ink ejected by the adjustment nozzle row 7 may not be appropriately set in the second ink ejection amount setting process.

However, in the present modified example, since the head 5 is an ink circulation type head, similarly to the embodiment described above, the fluctuation amount between the viscosity of ink ejected in step S32 immediately after the start of the second ink ejection amount setting process and the viscosity of ink ejected in step S22 can be suppressed, and the difference between the ejection amount of ink ejected in step S32 immediately after the start of the second ink ejection amount setting process and the ejection amount of ink ejected in step S22 can be suppressed in the adjustment nozzle row 7 disposed on the rightmost side, according to the study of the inventor of the present application. Therefore, in the second ink ejection amount setting process, the amount of ink ejected by the adjustment nozzle row 7 can be appropriately set.

In the second ink ejection amount setting process, the amount of ink ejected by the nozzle row 7 may be adjusted and set for all the nozzle rows 701 to 716. In this case, the amount of ink ejected by each nozzle row 7 may be adjusted and set in order for every nozzle row 7 from the nozzle row 701 disposed at the left end toward the nozzle row 716 disposed at the right end, or the amount of ink ejected by each nozzle row 7 may be adjusted and set in order for every nozzle row 7 from the nozzle row 716 disposed at the right end toward the nozzle row 701 disposed at the left end. Furthermore, in this case, the amount of ink ejected by each nozzle row 7 may be adjusted and set in order for every nozzle row 7 in the order of the nozzle row 715, the nozzle row 716, the nozzle row 713, the nozzle row 714, the nozzle row 711, the nozzle row 712, the nozzle row 709, the nozzle row 710, the nozzle row 707, the nozzle row 708, the nozzle row 705, the nozzle row 706, the nozzle row 703, the nozzle row 704, the nozzle row 701, and the nozzle row 702. Moreover, in the second ink ejection amount setting process, the amount of ink ejected by the adjustment nozzle row 7 may be adjusted and set in order for every adjustment nozzle row 7 from the adjustment nozzle row 7 disposed on the leftmost side to the adjustment nozzle row 7 disposed on the rightmost side.

### Another Embodiment

The embodiments described above are examples of a preferred embodiment of the present disclosure, but the present disclosure is not limited thereto, and various modifications can be made without changing the gist of the present disclosure.

In the embodiment described above, after calculating the voltage correction value in steps S10 and S40, the PC 3 may determine whether or not the number of calculation of the voltage correction value is less than a predetermined number of times, and determine whether or not the voltage correction value calculated in steps S10, S40 is within a predetermined reference range when the number of calculations of the voltage correction value is less than the predetermined number of times. In this case, when the voltage correction value is within the predetermined reference range, the process proceeds to steps S13 and S43.

In the embodiment described above, the carriage 6 may be moved to a predetermined position after the table 4 is lowered to a predetermined position and the electronic balance 11 on which the ink receiving container 12 is placed is installed on the table 4. Furthermore, in the embodiment described above, the mark of the placement position of the electronic balance 11 may not be printed on the table 4. In addition, in the embodiment described above, the head 5 may not be an ink circulation type head.

In the embodiment described above, the number of nozzle rows 7 that eject ink in steps S2, S22 and S32 may be two. That is, in steps S2, S22, and S32, the two nozzle rows 7 formed in one head 5 may eject ink. Furthermore, in the embodiment described above, the number of nozzle rows 7 formed in one head 5 may be one or may be three or more.

In the embodiment described above, the PC 3 may determine in steps S5, S25, and S35 whether or not the weight of the ink measured in steps S3, S23, and S33 is within a predetermined reference range. In this case, steps S4, S24 and S34 become unnecessary. Furthermore, in this case, the nozzle row 7 in which the weight of the ink measured in step S23 is outside the reference range becomes the adjustment nozzle row 7.

What is claimed is:

1. An adjustment method of a shaping device including a table on which a shaped object that is stereoscopic is shaped, and an inkjet head that ejects ink toward the table to form the shaped object, the adjustment method comprising:
an electronic balance installation process of placing an electronic balance for measuring a weight of an ink ejected by the inkjet head on the table; and
an ink ejection amount setting process of measuring the weight of the ink ejected by the inkjet head by the electronic balance placed on the table, and adjusting and setting an amount of ink ejected by the inkjet head based on a measurement result.

2. The adjustment method of the shaping device according to claim 1, wherein
the inkjet head comprises a piezoelectric element that ejects ink from a nozzle of the inkjet head; and
in the ink ejection amount setting process, a voltage applied to the piezoelectric element is adjusted and set.

3. The adjustment method of the shaping device according to claim 1, wherein the ink ejection amount setting process comprises:
an ink ejection process in which the inkjet head automatically ejects the ink to an ink receiving container placed on the electronic balance;
an ink weight measurement process in which the electronic balance automatically measures the weight of the ink ejected by the inkjet head in the ink ejection process; and
an ink ejection amount correction process of automatically correcting the amount of ink ejected by the inkjet head based on the measurement result of the ink weight measurement process.

4. The adjustment method of the shaping device according to claim 3, wherein
in the ink ejection amount setting process, the ink ejection process and the ink weight measurement process are performed again after the ink ejection amount correction process.

5. The adjustment method of the shaping device according to claim 4, wherein
the inkjet head is formed with a plurality of nozzles for ejecting ink;
in the inkjet head, the plurality of nozzles arrayed in a front and back direction orthogonal to an up and down direction form a nozzle row;
in the ink ejection process, the nozzle row automatically ejects ink;
in the ink weight measurement process, the electronic balance automatically measures the weight of the ink ejected by the nozzle row in the ink ejection process; and
in the ink ejection amount correction process, the amount of ink ejected by the nozzle row is automatically corrected based on the measurement result in the ink weight measurement process.

6. The adjustment method of the shaping device according to claim 5, wherein
the shaping device comprises: a plurality of the inkjet heads arrayed in a left and right direction orthogonal to the up and down direction and the front and back direction; and
one of the left and right directions is as a first direction, and the other of the left and right directions is as a second direction,
in the ink ejection amount setting process, the amount of ink ejected by the nozzle row is adjusted and set in order for every nozzle row from the nozzle row disposed at an end in the first direction toward the nozzle row disposed at an end in the second direction, with respect to all the nozzle rows included in the shaping device.

7. The adjustment method of the shaping device according to claim 5, wherein
the shaping device comprises: a plurality of inkjet heads arrayed in a left and right direction orthogonal to an up and down direction and a front and back direction; and
one of the left and right direction is as a first direction and the other of the left and right direction is as a second direction,
in the ink ejection amount setting process, the ink ejection process and the ink weight measurement process are performed in order for every nozzle row from the nozzle row disposed at an end in the first direction toward the nozzle row disposed at an end in the second direction, with respect to all the nozzle rows included in the shaping device, and
a determination process of automatically determining whether or not a weight of the ink measured in the ink weight measurement process or an amount of ink calculated based on a weight of the ink measured in the ink weight measurement process is within a reference range that is predetermined is also performed,
the amount of ink ejected by the nozzle row being adjusted and set in order for every nozzle row with respect to the nozzle row in which the weight or the amount of ink is outside the reference range after the determination process.

8. The adjustment method of the shaping device according to claim 7, wherein
the nozzle row in which the weight or the amount of ink is outside the reference range is as an adjustment nozzle row,
after the determination process, the amount of ink ejected by the adjustment nozzle row is adjusted and set in order for every nozzle row from the adjustment nozzle row disposed on a most second direction side toward the adjustment nozzle row disposed on a most first direction side.

9. The adjustment method of the shaping device according to claim 6, wherein
the inkjet head is an ink circulation type inkjet head, comprising:
an ink supply port to which the ink is supplied; and
an ink discharge port from which the ink is discharged.

10. The adjustment method of the shaping device according to claim 1, wherein the shaping device further comprises:
a table up-down moving mechanism that moves the table up and down;
a carriage on which the inkjet head is mounted; and
a carriage moving mechanism that moves the carriage in a main scanning direction; and
in the electronic balance installation process, the table is lowered to a predetermined position and the carriage is moved to the predetermined position, and then the electronic balance on which an ink receiving container is placed is installed on a lower side of the inkjet head.

11. The adjustment method of the shaping device according to claim 10, wherein
in the electronic balance installation process, a mark of a placement position of the electronic balance is printed on the table by the inkjet head before the table is lowered to a predetermined position.
